(19) United States
(12) Patent Application Publication
(10) Pub. No.: US 2006/0150238 A1
(43) Pub. Date: Jul. 6, 2006

(54) Method and apparatus of adaptive network policy management for wireless mobile computers

(75) Inventor: Anthony D'Agostino, Smithtown, NY (US)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Symbol Technologies, Inc., Holtsville, NY (US)

(21) Appl. No.: 11/028,814

(22) Filed: Jan. 4, 2005

(51) Int. Cl. H04L 9/00

(52) U.S. Cl. 726/1

(57) ABSTRACT

System(s) and method(s) are provided that utilize external resources and protect the integrity of data within a mobile communication device and data communicated with the mobile communication device. The device includes an extrinsic data analysis component that receives information about both an external environment and an internal state. The device also includes an adaptive policy manager (APM) component. The APM component is adapted to analyze and prioritize policies based upon received input from external resources, stimuli, threats and/or parameters. The method of protecting data integrity is performed automatically and autonomously with minimal user intervention and awareness. The APM component includes a profile component, a policy modification component, a rules component, an authentication component, and an access control component.

### FIELD OF INVENTION

The invention generally relates to computer systems, and in particular to a method and apparatus to utilize external resources and protect data integrity of a mobile computing device.

### BACKGROUND OF THE INVENTION

The usage of mobile communications systems utilizing mobile devices has become widespread and there is an ongoing and increasing need for the establishment of systems, methods and apparatus to maintain data integrity against unauthorized access while, concurrently, increasing user productivity.

Most networks utilize a requirement of successful compliance with security procedures in order to obtain a data connection to the network. These security procedures protect against unauthorized access to the network and are generally stored in local memory storage areas of the network. In such a system, the remote terminal provides its identity to the server by supplying various information, including user credential(s) information. The server then processes the user credentials and either permits or denies access to the network based upon the supplied information.

Typically, the user credentials must be entered and re-entered upon every authentication occurrence. The continuous re-entry of information places a burden on the user to continuously input the data numerous times as well as increasing user frustration. Additionally, users are generally not aware of a loss of data integrity nor are they usually able to make necessary changes to a predefined policy of the device. Additionally, if a network is inaccessible or “down” when the remote terminal is within its physical domain, access to local memory is prevented. Thus, the user is denied access to needed resources because there is no way to circumvent the network.

Therefore, there is a need to provide a remote device that can adapt dynamically, automatically and autonomously, to various network environments to ensure premium use of the device with a minimum amount of user awareness and user required intervention. This provides the user with a more flexible device that can avail itself to certain resources while, at the same time, properly safeguarding its data payload. It also decreases the necessary support from the device provider and, more importantly, increases user productivity.

### SUMMARY OF INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

According to an aspect of the invention, a portable communication device is provided. The device includes an extrinsic data analysis component that receives and analyzes information relating to an internal state and an external environment of the device and an adaptive policy manager (APM) component that employs the analyzed extrinsic information to dynamically enforce policies that affect data security of the device.

The APM component can include various internal components such as, for example, a profile component that receives a user input, an authentication component that validates a user based upon the user input, a policies component that retains a set of policies, a policy modification component that selectively overrides the retained set of policies and an access control component that selectively provides access to external resources and data.

According to another aspect of the invention, the APM component selectively enforces policies that affect data security of the device. For example, the APM component can selectively enforce the policies based upon a defined set of criteria specifying normal behavior in a network environment. The APM component provides prioritization of the policies based upon an assessment of resources available to the device and threats external to the portable communication device. The APM component can automatically and autonomously select and implement a set of actions based upon the policy prioritization. These policies can also be selected and enforced by the APM component based upon an inferred user state.

According to another aspect of the invention, the APM component is configurable to operate in various user model modes or states, which can be a high-threat model mode, a low-threat model mode or any state there between. In the low-threat model mode, the APM component uses separate criteria, such as user credentials, to determine the availability of local memory resources. In a high-threat model mode, the device can be denied assess to all or some external devices.

According to another aspect of the invention, a communication architecture is provided that includes a network and an adaptive policy manager (APM) component. The network includes a plurality of stimuli, such as, for example, external resources and external threats. The APM component provides prioritization of policies based upon an assessment of the plurality of stimuli. The policies are a set of rules indicating expected behavior in a particular environment. The prioritization of policies determines a user model mode, which can be a high-level mode, a low-level mode or any state there between.

According to yet another aspect of the invention is a method of providing data security in a portable computing environment. The method includes assessing an environment external to the mobile communication device. The method receives information from external resources and prioritizes internal system priorities based upon the assessed external environment. The method further selects an action set based upon the received information and implements the selected action set to provide optimal performance of the mobile communication device.

According to still another aspect of the invention, the method further includes generating parameters that identify criteria, such as user credentials, for at least one stimuli and storing the parameters in a memory location. The parameters are selectively enforced based upon the identified criteria. The method is adapted to dynamically assess any resources and threats external to the portable computing environment. Selecting an action set based upon the received use model information can be performed autonomously.

According to still another aspect of the invention, the method further includes assessing a threat mode based upon received information and determining if user criteria are acceptable to continue operating in that network based on the assessed threat mode. If the user criteria are acceptable, the method can also determine available local memory resources and establish a network connection to those available local memory resources. If the user criteria are not acceptable, the method can deny access to the available local memory resources.

To the accomplishment of the foregoing and related ends, certain illustrative aspects of the invention are described herein in connection with the following description and annexed drawings. There aspects are indicative, however, of but a few of the various ways in which the principles of the invention can be employed and the subject invention is intended to include all such aspects and their equivalents. Other aspects, advantages and novel features of the invention will become apparent from the following detailed description of the invention when considered in conjunction with the drawings.

### BRIEF DESCRIPTION OF DRAWINGS

FIG. 1 illustrates a high-level architecture in accordance with an aspect of the invention.

FIG. 2 illustrates an adaptive policy manager component in accordance with an aspect of the invention.

FIG. 3 illustrates exemplary components of the policy manager component according to an aspect of the invention.

FIG. 4 illustrates additional exemplary components in accordance with an aspect of the invention.

FIG. 5 illustrates another exemplary component utilized according to an aspect of the invention.

FIG. 6 illustrates a methodology of enforcing policies according to an aspect of the invention.

FIG. 7 illustrates a methodology of modifying policies in accordance with an aspect of the invention.

FIG. 8 illustrates a methodology of determining a use model in accordance with an aspect of the invention.

FIG. 9 illustrates a schematic block diagram of a computer operable to execute the invention.

FIG. 10 illustrates a device operate to execute an aspect of the invention.

### DETAILED DESCRIPTION OF THE INVENTION

The subject invention is now described with reference to the accompanying drawings, which form a part hereof, wherein like reference numerals are used to refer to like elements throughout. In the following description, for purposes of explanation, numerous specific details are set forth in order to provide a thorough understanding of the invention. It may be evident, however, that the invention may be practiced without these specific details. In other instances, well-known structures and devices are shown in block diagram form in order to facilitate describing the invention. It is to be understood that other embodiments may be utilized and changes may be made without departing from the scope of the invention.

As used in this application, the terms “component”, “system” and “module” are intended to refer to a computer-related entity, either hardware, a combination of hardware and software, software, or software in execution. For example, a component may be, but is not limited to being, a process running on a processor, programmable hardware such as an ASIC or FPGA, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

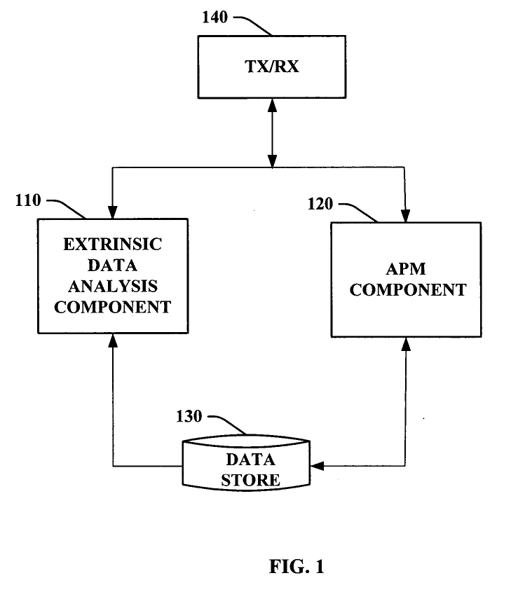

Referring initially to FIG. 1, illustrated is a high-level architecture of a wireless computing device according to an aspect of the invention. The wireless computing device includes an extrinsic data analysis component 110 that communicates with an adaptive policy manager component (APM) component 120 and a data store 130.

The extrinsic data analysis component 110 receives information relating to an external environment, such as through a transceiver/receiver 140. The extrinsic data analysis component 110 analyzes the received information, for example, by retrieving information captured in a data store 130. The information captured in the data store may include data regarding expected behavior in various network environments.

The extrinsic data analysis component 110 transmits the analyzed information to the APM component 120 where policies that affect data security are dynamically enforced. The APM component 120 analyzes the information from the extrinsic data analysis component 110 with additional information received from, for example, the data store 130. The APM component 120 is adapted selectively to allow the wireless computing device access to various resources and data in the external environment.

The APM component 120 employs information received from the extrinsic data analysis component 110 and dynamically enforces a policy or a set of policies that affect data security of the wireless computing device and access to resources in the network environment. A policy is a set of rules defining what normal behavior should be in a specific situation.

For example, the user can specify a set of top level rules that correspond to a desired network environment. The policy or set of polices are generated for use on the portable communication device and identify what actions should and/or should not be taken for a given set of stimuli. The policy, written in software, can be generated for use in a particular mobile communication environment.

When the APM component 120 obtains information concerning the communicating environment, the information is stored in a memory location. The predefined policy is adapted by performing a query using the expected nominal behavior and comparing it with a defined set of criteria from the received network environment information. The APM component 120 adapts the policy to the current environment automatically and autonomously by selectively enforcing certain policies based upon the defined set of criteria. This provides optimal performance of the wireless computing device while protecting data integrity.

For example, the policy or set of policies can be written in software to produce an action based on a successful test of the defined set of criteria. The defined set of criteria may incorporate, for example, certain threats to the wireless device, each threat given a priority or threat level, such as “1” to “5”, with “5” being the highest priority or threat level, for example. When inputs are received that correspond to a particular threat, the existence of that input is ranked according the priority or threat level. For example, if a particular ranking indicates a high threat level to the portable communication device it is assigned a “5”. When the portable device receives an input indicating that a particular threat is operating within the network, it queries the nominal behaviors against the input and determines what level threat is present. The APM component can be configured to take account of each threat separately or a plurality of threats contained in the network that when combined exceed a predetermined threshold or tolerance level. The APM component then takes appropriate action, based upon the predefined policy relating to the threshold or tolerance level of the portable device. The policy may be, for example, to restrict access to/from a particular device or resource that is causing the threat or disconnect the portable device from the computing environment.

Therefore, the user only needs to specify a set of top-level rules and the APM component 120 is adapted to interpret and execute those rules on a case-by-case basis depending upon the known and sampled network parameters in which the portable communication device is operating. The automatic and autonomous function of the APM component 120 provides a flexible wireless computing device that can avail itself to various resources while concurrently properly safeguarding its data payload. The APM component 120 can be configured to continuously assess the external environment or only periodically access the environment to save system resources.

The APM component 120 can also receive input directly from the user based upon user actions or requests to access external resources. The APM component can also infer from the user actions that may be desired by the user and access the environment for achieving a proper result and provide the user optimal performance of the portable device.

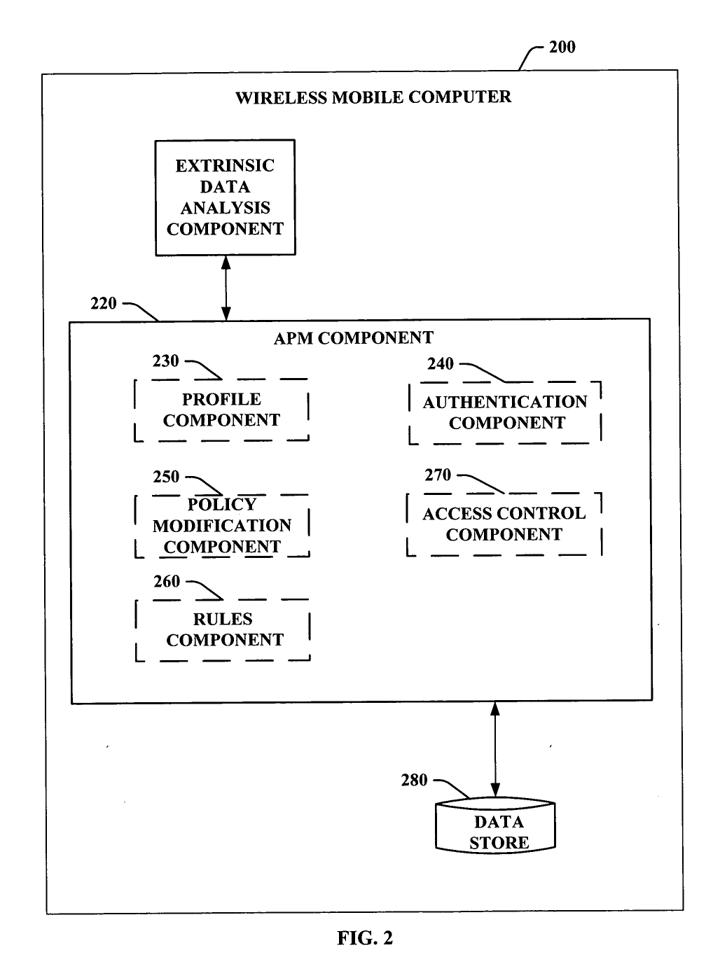

Referring now to FIG. 2, illustrated is a wireless mobile computer 200 the includes an extrinsic data analysis component 210 and an adaptive policy management (APM) component 220. The extrinsic data analysis component 210 is adapted to receive information about an external environment and an internal state of the mobile computer 200.

The external information includes available network resource and network parameters. Examples of the available network resources are printers, PBX's, file servers, etc. Parameters include network signal strength, network performance, average network packet size, and network threat level. The internal state of the mobile computer 200 includes current user state information, resource request information, etc.

The APM component 220 can be suitably configured to maintain data integrity via a profile component 230, an authentication component 240, a policy modification component 250, a rules component 260 and an access control component 270. The APM component can also receive/send information to the extrinsic data analysis component 210 and the data store 280.

The profile component 220 identifies a user based upon user input data. The profile component 220 also captures user domain information as well as the user's authority in a particular network, such as security clearance levels, etc.

The authentication component 230 retains information about various users of the device. In some instances, a mobile computer may be used by more than one person. The device retains the user information to verify which user is signed-on at a particular time, and allowing that person access to resources and data that are relevant to that person.

The rules component 260 contains a rule or set of rules that indicate expected behavior in a particular environment. These rules help ensure data security of both the mobile computer 200 and the data communicated to and from the mobile computer 200. The rules can also relate to external devices or resources available in the external network environment that have approval to communicate with the mobile computer 200.

The policy modification component 250 is able to capture data regarding an environment external to the computer as well as information regarding the device itself. The policy modification component 250 is configured to receive user input information. For example, a user specifies a set of top-level rules and inputs that information into the computer. These rules will be interpreted and executed by the computer based upon the current operating environment.

The access control component 270 is capable of detecting user state information. It also maintains an internal register of files or databases accessible and available to the computer. Additionally, the access control component detects objects or resources available to the computer.

Through use of the individual components, the APM component 220 selectively enforces policies based upon a defined set of criteria. For example, the APM component 220 may be configured with a set of rules that define what normal behavior should be in a particular environment. If a behavior is expected, it is given a ranking of “1” or “0”, for example. If a behavior is not expected, but does not pose a significant threat, it is given a ranking, such as “2” or “3”. If a behavior is unacceptable or poses a significant threat to the device or data, it is given a ranking of “4” or “5”. Thus, when that particular behavior is detected by the APM component, it is recognized in relationship to its ranking and the APM component takes appropriate action based upon the defined policies or rules relating that that particular behavior.

For example, if the network is a work related network and only workers or those with certain access privileges are allowed to access local memory storage of the work related network, the policy may be enforced by denying the device access to that network if the device does not have the specified credentials. In this way, sensitive work related data would only be accessible when the portable communication device is connected to a work related network and has the proper credentials. These credentials may include various parameters, such as access codes, access privileges and rights, user database rights, user clearance levels, department, etc.

The APM component 220 can selectively enforce policies depending upon a set of criteria that affects the specific portable communication device. The set of criteria are inputs to the APM component 220 and are evaluated by the APM component 120. The set of criteria can be resources available to the portable communication devices. These available resources include printers, PBX's, and file servers, etc. Another set of criteria may be external stimuli including parameters based on various factors including network signal strength, network performance, average network packet size, and network threat levels, etc.

The APM component 220 is capable of providing classification or ranking of policies based on a dynamic assessment of the resources, stimuli and threats external to the wireless mobile computer 200. The APM component 220 autonomously selects and implements a set of actions based upon its assessment of the resources and stimuli. This is performed automatically and autonomously by the APM component 220 and does not require user intervention. Thus, allowing the user premium use of the mobile computer without requiring the user to be aware of each resource and/or stimuli and intervening for each specific situation.

For example, the APM component may enforce a policy by denying the wireless mobile computer access to certain areas of a local memory storage device if the local memory storage device is not recognized or is of unknown data reliability. This would allow sensitive data on the computer to be protected from access by the local memory storage device, maintaining the integrity of both the local memory storage device and the mobile computer. In this situation, the APM component can be configured to operate in a high threat use mode or a low threat use mode. While in low threat use mode, the APM manager can look at other criteria, such as user credentials, to determine the availability of local memory resources that the computer can utilize in place of the local memory storage device. The user credentials relate to various rights or privileges of the user and may be assigned and/or determined by a user's log on information. While in high threat use mode, the APM component can deny the computer access to some or all external devices or resources.

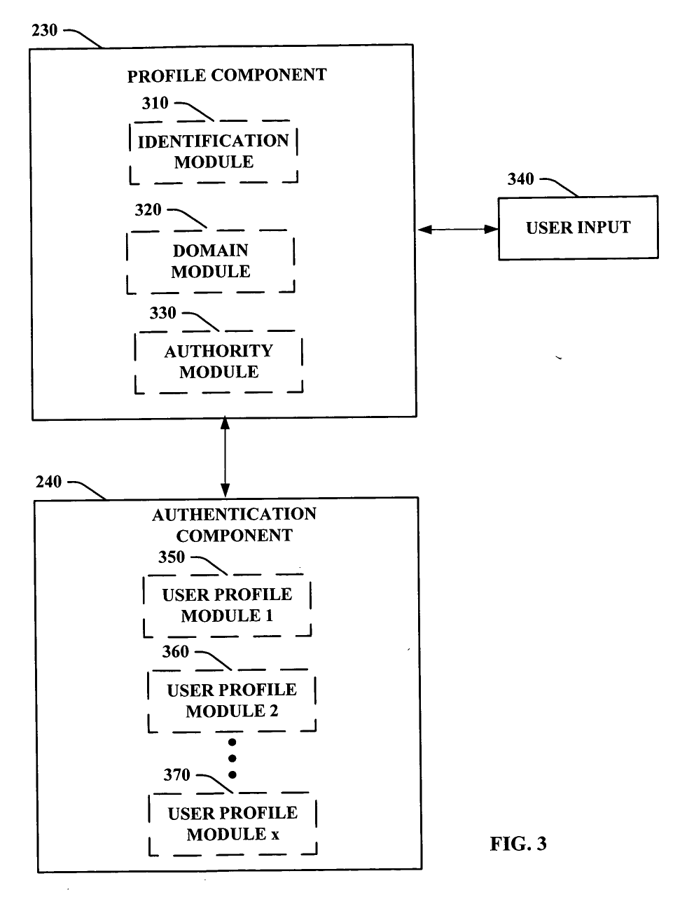

FIG. 3 illustrates exemplary components contained in the APM component according to an aspect of the invention. A profile component 230 includes an identification module 310, a domain module 320 and an authority module 330. The profile component 230 is capable of receiving user input 240, which includes changing a user profile to allow a higher/lower access level. The user input 240 can be either from the user, administrator or computer manufacturer. The identification module 310 contains user identification information, such as user credentials, user access rights, etc. The authority module 330 of the profile component 230 stores additional information about the user, such as authority levels. The profile component 230 works autonomously or may interact with an authentication component 240.

The authentication component 240 authenticates multiple user access rights based upon user input criteria. A user₁ module 350 contains information regarding user1, which includes user credential information, user access rights, etc. User₂ module contains all known information about user2. The authentication component 240 contains information for all users of the device and contains as many user profile modules as required, shown as userₓ profile module.

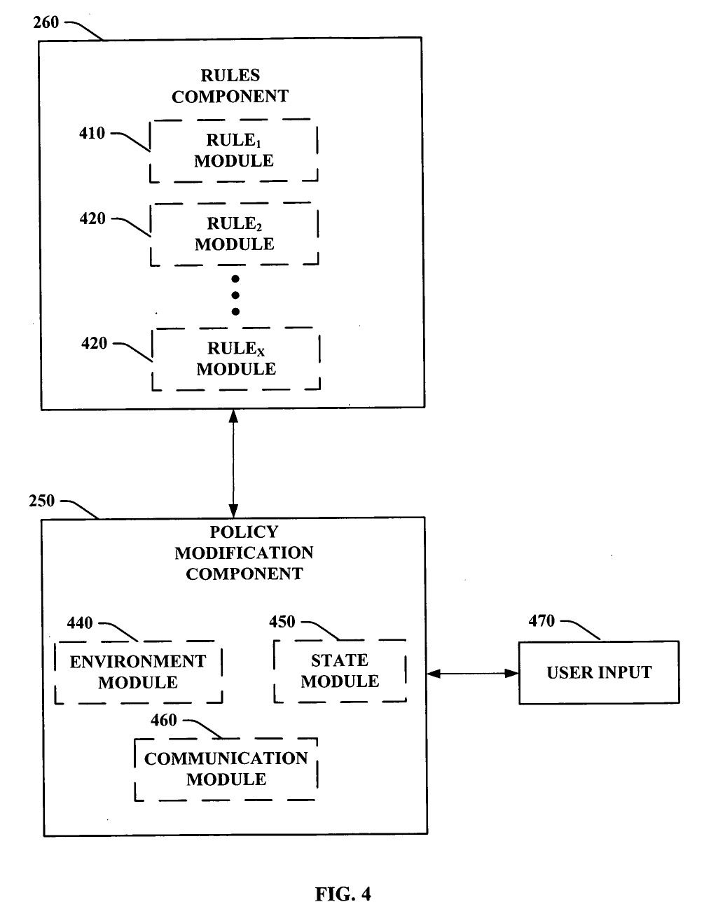

FIG. 4 illustrates exemplary components utilized in and by the APM component according to another aspect of the invention. A rules component 260 contains rules modules 410, 420 that define the expected behavior of the device in a network environment. Each rules module stores a different set of rules and the rules component 260 may contain a large number of rules modules 430. The rules component 260 interacts with the policy modification component 250 to implement a policy to automatically and autonomously adapt to the computing environment. Both the rules component 260 and the policy modification component can work autonomously or together to bring out the desired result.

The policy modification component 250 includes an environment module 450, a state module 450 and a user input 470. The user input 470 includes a set of top-level rules to be used in the network environment that can be provided by a user, administrator or computer manufacturer. The environment module 440 captures information regarding the external environment of the device. This may include available resources or potential threats to the mobile device. Also included in the policy modification component 250 is a state module 450 that detects an internal state of the mobile device.

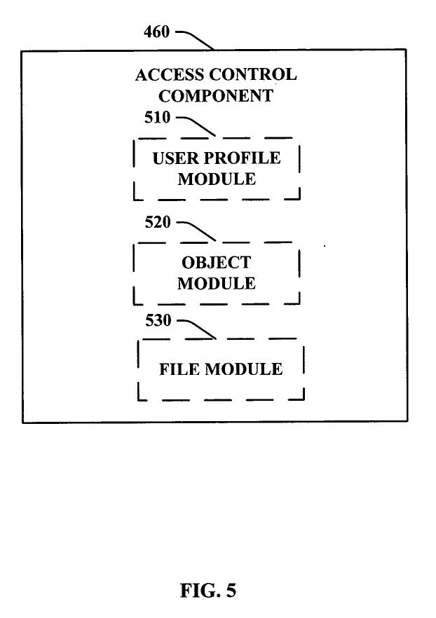

FIG. 5 illustrates an access control component for use with the invention. The access control component 270 includes a user profile module 510, a file module 530 and an object module 520. The user profile module 510 contains user access rights information. The file module 530 maintains a listing of files that are available for use by the mobile device. It is understood that files include any data accessible by the mobile device and is not limited to documents. The object module 520 maintains a listing of the objects or resources that are available to the device at any given time.

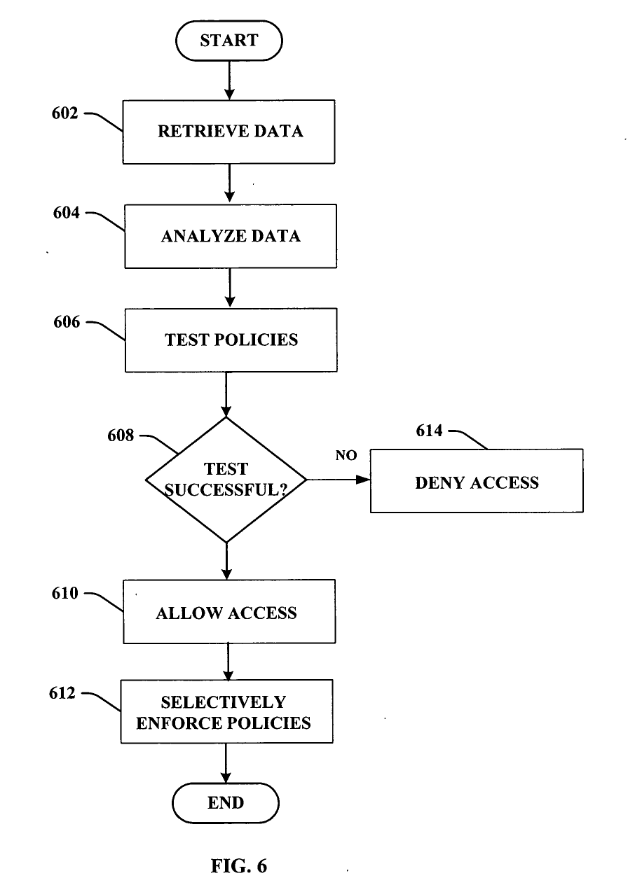

Certain methodologies that can be implemented in accordance with the invention are illustrated in FIGS. 6-8. While, for purposes of simplicity of explanation, the methodologies are shown and described as a series of blocks, it is to be understood and appreciated that the invention is not limited by the order of the blocks, as some blocks can, in accordance with the invention, occur in different orders and/or concurrently with other blocks from that shown and described herein. Moreover, not all illustrated blocks may be required to implement the methodologies in accordance with the invention.

Referring initially to FIG. 6, illustrated is a methodology 600 of selectively enforcing policies in a mobile computer in accordance with an aspect of the invention. The method starts when a mobile computer powers up and runs either continuously while the computer is operating or periodically to conserve system resources. At 602 data from the mobile computer and external to the mobile computer is retrieved, such as via an extrinsic data analysis component. The retrieved data includes various use states of the mobile computer including user information and computer state information. The external information includes available resources the mobile computer can access such as printers, file servers, PBX's, IR (Infra-Red) ports, serial/USB ports, etc.

At 604, the retrieved data is analyzed via for example, the extrinsic data analysis component. At 606, the analyzed data is compared or tested against a set of policies, for example by an adaptive policy manager (APM) component, and are prioritized. The set of policies are located, for example in a data store, and represent those actions that should or should not be taken for a given set of analyzed data. The method autonomously selects an action or an action set based on the policy prioritization.

For example, the method is able to detect if a mobile computer is not connected to a specific network but the user is attempting to make the connection. The method is able to detect that the mobile computer is not connected based upon receiving an input and analyzing the input against a set of rules or policies. If it is determined that the mobile computer is to be denied access, the method will inhibit the computer accessing the network, preventing sensitive work related data being available to non-network devices.

At 608, a determination is made if the tested policies represent the defined nominal criteria. If the tested policies do not meet the nominal criteria, the method continues at 614 and access to external resources or data is denied. If the tested policies substantially match the nominal criteria, the method continues at 610 and access to the external resource or data is allowed.

The method continues at 612 where the APM component selectively enforces policies based upon the retrieved and analyzed data. The method, through a dynamic assessment of resources, stimuli and threats external to the mobile communication device is able to prioritize the policy or set of policies and take the appropriate action necessary. The method may generate a parameter that identifies criteria for at least one stimuli and stores the parameter in a memory location. Using this stored parameter the method can selectively enforce the parameter based upon the identified criteria.

The method implements selected action(s) by either allowing or not allowing access to a particular resource based on the inputted resource data, stimuli and/or threats. The method is also able to determine a use mode based upon the input information and implement an action based upon that use mode. Depending on the use mode, the device may be configured to operate in a high threat use mode or a low threat use mode. In a high threat use mode the device may have restricted access to all or some external resources or devices due to loss of data integrity. In a low threat use model, the method looks at other criteria, such as user credentials, to determine if, instead of a work related network connection, there is other local memory resources available based upon the predefined criteria. The user credentials include user access rights, user clearance level, etc.

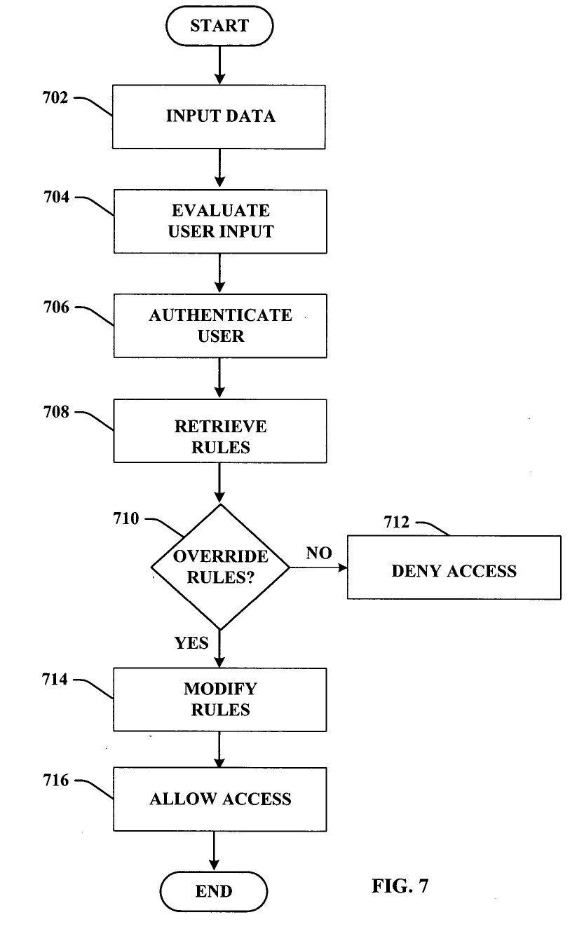

FIG. 7 is a methodology of modifying rules to allow a mobile computer to access external resources or data. The method starts at 702 with data input to the mobile computer, which includes external environment information as well as user information. The external environment information includes a listing of all system resources available as well as various parameters. These parameters may include indication of average network packet size, network threat level, network performance, network signal strength, etc. Other inputs are threats that may jeopardize the integrity of the device or data communicated with the device. Another input includes an assessment of whether the mobile device is in a particular operating network and whether or not that device has the proper access for that network. The mobile device is adapted to receive this information or to actively seek the information though user requests or an inferred user state. The input data is then evaluated 704 against a known set of data to verify a proper working environment.

At 706, the method authenticates the particular user of the mobile computer out of a set of possible users. At 708 rules are retrieved that indicate expected behavior in a particular environment. These rules help ensure data security of both the portable communication device and the data communicated to and from the portable communication device. The rules can also relate to external devices or resources available in the external network environment that have approval to communicate with the portable device.

At 710, a determination is made to override the rules. If it is determined that the rules should not be overridden, at 712 the user is denied access to the requested resource or data. If it is determined that the rules should be overwritten, at 714 the rules are modified. After the rules are modified, the user is allowed access to the requested resources or data.

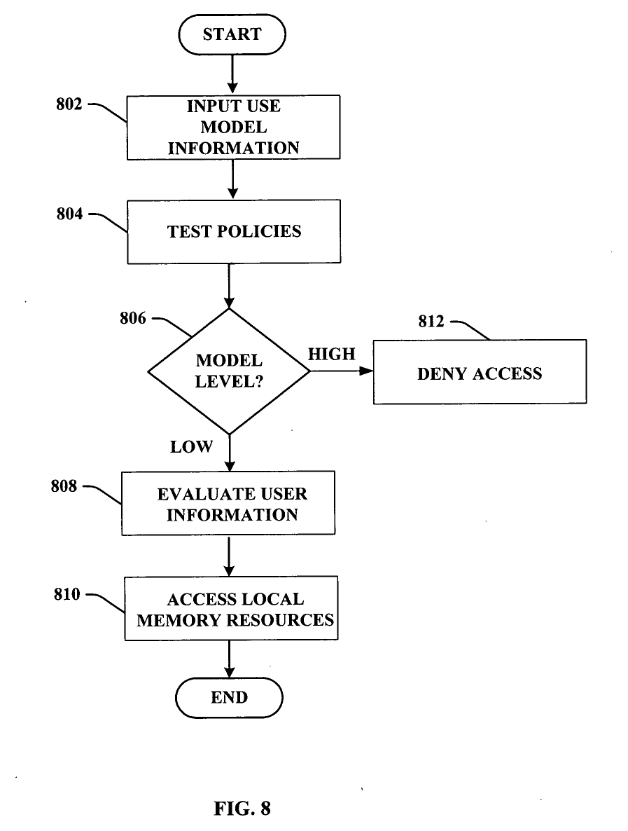

Referring now to FIG. 8, illustrated is a methodology that determines use model criteria. The method starts 802 when use model information is received. The method accesses the current external environment of the mobile communication device. This external environment includes all system resources available as well as various parameters. These parameters may include indication of average network packet size, network threat level, network performance, network signal strength, etc.

At 806 policies are tested according to the use model information. The method receives a defined set of criteria including information from the system resources and/or parameters and analyzes or compares the received information against a system policy based upon the predefined rules or policies internal to the mobile computing device. These rules or policies are predefined and, for example, are stored in a computer readable medium of the mobile computing device to establish nominal behavior standards for a given network environment. The policies or rules are located internal to the mobile communication device to avoid a situation where a work related network may be “down” or unable to communicate. By employing internal policies or rules, the mobile communication device is still able to access local resources and/or local memory even when a work related network is unresponsive.

At 808, a determination is made whether the mobile computer is at a high use model level or a low use model level. If the input data indicates a threat level, such as a work related network being inaccessible, the threat mode is assessed and selected. This assessment is performed by analyzing various policies or rules and prioritizing those policies or rules based upon the input data. If it is determined that the mobile computer is in a high use model, the method switches to a high use model and access to external resources and data is denied or limited at 814. If the threat mode is low, the method switches to low use model and the method evaluates user information at 810. For example, credentials, user access rights to file servers, etc. may be analyzed to determine if that particular user has the appropriate access level to connect to a work related network. If the criteria are not acceptable, the method may deny the user access to a network connection. The method continues at 812 to determine the available local memory resources that can be utilized by the mobile communication device in place of a work related network, for example.

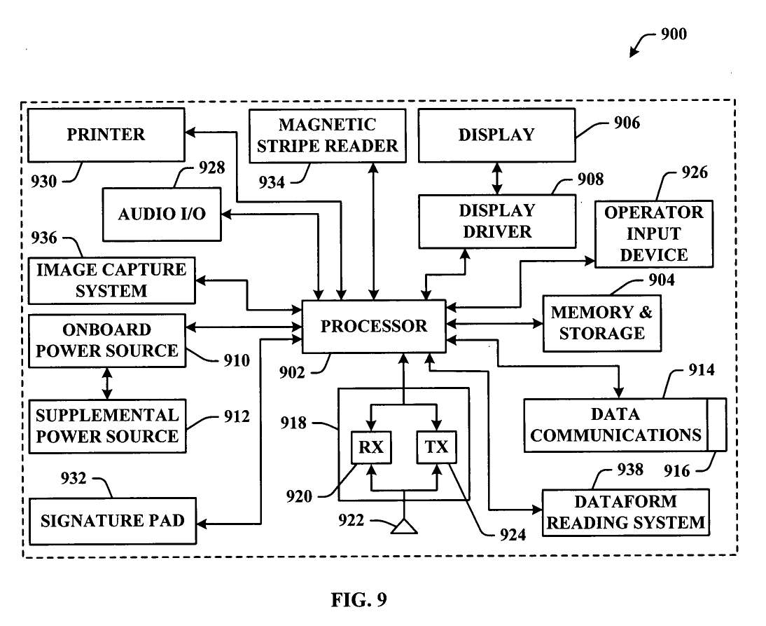

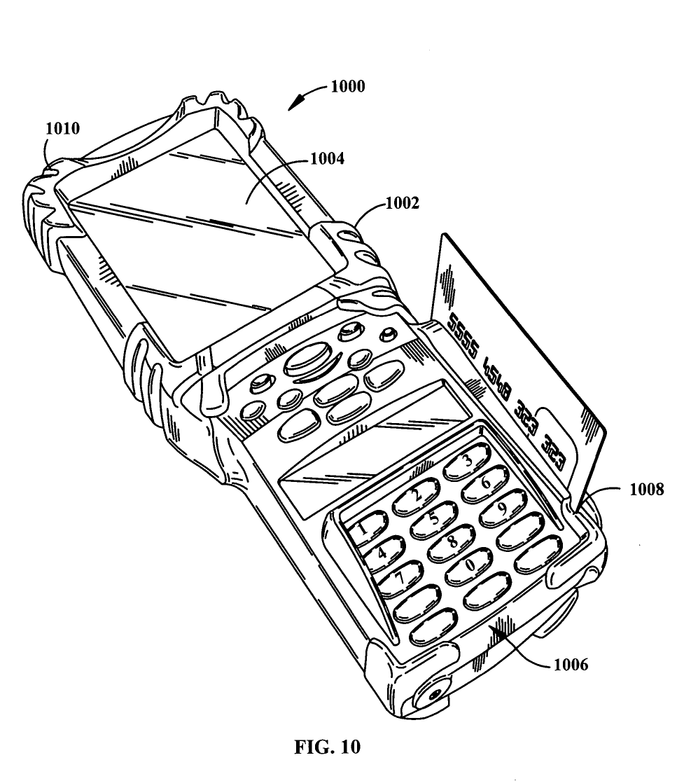

Referring now to FIG. 9, there is illustrated a schematic block diagram of a portable hand-held terminal device 900 (similar to the portable scanning device 1000 as illustrated in FIG. 10) according to one aspect of the present invention, in which a processor 902 is responsible for controlling the general operation of the device 900. The processor 902 is programmed to control and operate the various components within the device 900 in order to carry out the various functions described herein. The processor 902 can be any of a plurality of suitable processors. The manner in which the processor 902 can be programmed to carry out the functions relating to the present invention will be readily apparent to those having ordinary skill in the art based on the description provided herein.

A memory 904 connected to the processor 902 serves to store program code executed by the processor 902, and serves as a storage means for storing information such as user credential and receipt transaction information and the like. The memory 904 can be a non-volatile memory suitably adapted to store at least a complete set of the information that is displayed. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information, and the processor 902 could include a program for alternating or cycling between various sets of display information.

A display 906 is coupled to the processor 902 via a display driver system 908. The display 906 can be a color liquid crystal display (LCD), plasma display, or the like. In this example, the display 906 is a ¼ VGA display with sixteen levels of gray scale. The display 906 functions to present data, graphics, or other information content. For example, the display 906 can display a set of customer information, which is displayed to the operator and can be transmitted over a system backbone (not shown). Additionally, the display 906 can display a variety of functions that control the execution of the device 900. The display 906 is capable of displaying both alphanumeric and graphical characters.

Power is provided to the processor 902 and other components forming the hand-held device 900 by an onboard power system 910 (e.g., a battery pack). In the event that the power system 910 fails or becomes disconnected from the device 900, a supplemental power source 912 can be employed to provide power to the processor 902 and to charge the onboard power system 910. The processor 902 of the device 900 induces a sleep mode to reduce the current draw upon detection of an anticipated power failure.

The terminal 900 includes a communication subsystem 914 that includes a data communication port 916, which is employed to interface the processor 902 with a remote computer. The port 916 can include at least one of Universal Serial Bus (USB) and IEEE 1394 serial communications capabilities. Other technologies can also be included, for example, infrared communication utilizing an infrared data port.

The device 900 can also include a radio frequency (RF) transceiver section 918 in operative communication with the processor 902. The RF section 918 includes an RF receiver 920, which receives RF signals from a remote device via an antenna 922 and demodulates the signal to obtain digital information modulated therein. The RF section 918 also includes an RF transmitter 924 for transmitting information to a remote device, for example, in response to manual user input via a user input device 926 (e.g., a keypad) or automatically in response to the completion of a transaction or other predetermined and programmed criteria. The transceiver section 918 facilitates communication with a transponder system, for example, either passive or active, that is in use with product or item RF tags. The processor 902 signals (or pulses) the remote transponder system via the transceiver 918, and detects the return signal in order to read the contents of the tag memory. In one implementation, the RF section 918 further facilitates telephone communications using the device 900. In furtherance thereof, an audio I/O section 928 is provided as controlled by the processor 902 to process voice input from a microphone (or similar audio input device) and audio output signals (from a speaker or similar audio output device). In another implementation, the device 900 can provide voice recognition capabilities such that when the device 900 is used simply as a voice recorder, the processor 902 can facilitate high-speed conversion of the voice signals into text content for local editing and review, and/or later download to a remote system, such as a computer word processor. Similarly, the converted voice signals can be used to control the device 900 instead of using manual entry via the keypad 926.

Onboard peripheral devices, such as a printer 930, signature pad 932, and a magnetic strip reader 934 can also be provided within the housing of the device 900 or accommodated externally through one or more of the external port interfaces 916.

The device 900 can also include an image capture system 936 such that the user can record images and/or short movies for storage by the device 900 and presentation by the display 906. Additionally, a dataform reading system 938 is included for scanning dataforms. It is to be appreciated that these imaging systems (936 and 938) can be a single system capable of performing both functions.

FIG. 10 is provided to assist in understanding and to provide context to an embodiment of the present invention. Specifically, FIG. 10 illustrates an example of a handheld terminal 1000 in accordance with an aspect of the present invention.

The handheld terminal 1000 includes a housing 1002 which can be constructed from a high strength plastic, metal, or any other suitable material. The handheld terminal 1000 includes a display 1004. As is conventional, the display 1004 functions to display data or other information relating to ordinary operation of the handheld terminal 1000 and/or mobile companion (not shown). For example, software operating on the handheld terminal 1000 and/or mobile companion can provide for the display of various information requested by the user. Additionally, the display 1004 can display a variety of functions that are executable by the handheld terminal 1000 and/or one or more mobile companions. The display 1004 provides for graphics based alpha-numerical information such as, for example, the price of an item requested by the user. The display 1004 also provides for the display of graphics such as icons representative of particular menu items, for example. The display 1004 can also be a touch screen, which can employ capacitive, resistive touch, infrared, surface acoustic wave, or grounded acoustic wave technology.

The handheld terminal 1000 further includes user input keys 1006 for allowing a user to input information and/or operational commands. The user input keys 1006 can include a full alphanumeric keypad, function keys, enter keys, etc. The handheld terminal 1000 can also include a magnetic strip reader 1008 or other data capture mechanism (not shown). An electronic signature apparatus can also be employed in connection with the magnetic strip reader or a telecheck system.

The handheld terminal 1000 can also include a window 1010 in which a bar code reader/bar coding imager is able to read a bar code label, or the like, presented to the handheld terminal 1000. The handheld terminal 1000 can include a light emitting diode (LED) (not shown) that is illuminated to reflect whether the bar code has been properly or improperly read. Alternatively, or additionally, a sound can be emitted from a speaker (not shown) to alert the user that the bar code has been successfully imaged and decoded. The handheld terminal 1000 also includes an antenna (not shown) for wireless communication with a radio frequency (RF) access point; and an infrared (IR) transceiver (not shown) for communication with an IR access point.

What has been described above comprises examples of the invention. It is, of course, not possible to describe every conceivable combination of components or methodologies for purposes of describing the invention, but one of ordinary skill in the art can recognize that many further combinations and permutations of the invention are possible. Accordingly, the invention is intended to embrace all such alterations, modifications and variations that fall within the spirit and scope of the appended claims. Furthermore, to the extent that the term “comprises” is used in either the detailed description or the claims, such term is intended to be inclusive in a manner similar to the term “comprising” as “comprising” is interpreted when employed as a transitional word in a claim.

What is claimed is:

1. A portable communication device comprising:
an extrinsic data analysis component that receives and analyzes information relating to internal state and external environment of the device; and
an adaptive policy manager (APM) component that employs the analyzed extrinsic information to dynamically enforce policies that affect data security of the device.

2. The portable communication device of claim 1, the APM component further comprising a profile component that receives a user input.

3. The portable communication device of claim 2, the APM component further comprising an authentication component that validates a user based upon the user input.

4. The portable communication device of claim 1, the APM component further comprising:
a policies component that retains a set of policies; and
a policy modification component that selectively overrides the retained set of policies.

5. The portable communication device of claim 1, the APM component further comprising an access control component that selectively provides access to external resources and data.

6. The portable communication device of claim 1, the APM component selectively enforcing the policies based upon a defined set of criteria.

7. The portable communication device of claim 1, the APM component providing prioritization of the policies based upon an assessment of resources available to the portable communication device.

8. The portable communication device of claim 3, the APM component providing prioritization of the policies based upon threats external to the portable communication device.

9. The portable communication device of claim 1, the APM component autonomously selecting and implementing a set of actions.

10. The portable communication device of claim 1, the APM component enforcing the policies based upon an inferred user state.

11. The portable communication device of claim 1, the APM component is configurable to operate in a use model.

12. The portable communication device of claim 11, the use model is a high-threat model or a low-threat model.

13. The portable communication device of claim 12, the APM component in the low-threat model using separate criteria to determine availability of local memory resources in lieu of a work related network connection.

14. The portable communication device of claim 13, the separate criteria is a user credential.

15. A communication architecture, comprising:
a network that includes a plurality of resources;
a data analysis component that captures data about the plurality of resources; and
an adaptive policy manager (APM) component that provides prioritization of policies based upon an assessment of the plurality of resources.

16. The communication architecture of claim 15, the plurality of resources comprising external resources and external threats.

17. The communication architecture of claim 15, the policies are a set of rules indicating expected behavior in a particular environment.

18. The communication architecture of claim 15, the APM component determining a use model.

19. The communication architecture of claim 18, the use model is either a high-level model or a low-level model.

20. A method of providing data security in a portable computing environment, comprising:
assessing an external environment;
receiving information from resources in the external environment;
prioritizing system policies based upon the received information;
selecting an action based upon the prioritized system policies; and
implementing the selected action.

21. The method of claim 20, prioritizing system priorities based upon the assessed external environment further comprising:
testing a defined set of criteria; and
comparing the defined set of criteria with a system policy.

22. The method of claim 21, prioritizing system priorities based upon the assessed external environment further comprises dynamic assessment of resources and threats external to the portable computing environment.

23. The method of claim 20, selecting an action set based upon the received information is performed autonomously.

24. The method of claim 20, further comprising:
selecting a use mode based upon the received information; and
determining if user criteria are acceptable based on the assessed use mode.

25. The method of claim 24, further comprising:
determining available local memory resources if the user criteria is acceptable; and
establishing a network connection to the available local memory resources.

26. The method of claim 24, further comprising denying access to local memory resources if the user criteria are unacceptable.

27. A computer readable medium of a portable device to provide safe operation of the portable device, comprising:
a component that evaluates an external environment and develops a query;
a component that combines a set of policies with the developed query to prioritize the set of policies; and
a component that implements action sets based on the prioritized set of policies.

28. A portable communication system that protects data integrity, comprising:
means for querying a portable communication system;
means for selecting a set of rules based upon the queried system; and
means for selectively enforcing the set of rules.
